(19) United States
(12) Patent Application Publication
(10) Pub. No.: US 2014/0312786 A1
(43) Pub. Date: Oct. 23, 2014

(54) LED LIGHT STRIP COMPRISING TWO OR MORE INDEPENDENT CIRCUITS MEETING SEPARATE POWER CONSUMPTION AND ILLUMINATION OUTPUT REQUIREMENTS

(71) Applicant: CRANE MERCHANDISING SYSTEMS, INC., BRIDGETON, MO (US)

(72) Inventors: Chengzhi Tang, Aiken, SC (US); Brian McCain, Aiken, SC (US)

(21) Appl. No.: 14/214,169

(22) Filed: Mar. 14, 2014

Related U.S. Application Data
(60) Provisional application No. 61/799,893, filed on Mar. 15, 2013.

(51) Int. Cl. H05B 33/08; H05B 37/02

(52) U.S. Cl. CPC H05B 33/0821; H05B 37/0281
USPC 315/185 R

(57) ABSTRACT

A vending machine includes a controller coupled to at least one light emitting diode (LED) light strip mounted within the vending machine and illuminating an interior thereof. The LED light strip includes an input terminal that receives one or more signals corresponding to a mode of the LED light strip, an LED mounting board supports a plurality of LED chips forming a plurality of independent circuits each including a serially-connected subset of the LED chips, and electrical circuit components (resistor, input terminal, and/or output terminal) that cause the respective circuit to function independently from remaining circuits in the LED light strip. The controller selectively powers one or more of the independent circuits in the LED light strip to meet either a power consumption requirement or an illumination output specification, leaving off any remaining independent circuits not corresponding to the specified mode.

### CROSS-REFERENCE TO RELATED APPLICATIONS

This application claims priority under 35 U.S.C. §119(e) to the subject matter of U.S. Provisional Patent Application No. 61/799,893 (Attorney Docket CRAN01-00551) entitled “LED LIGHT COMPRISING TWO OR MORE INDEPENDENT CIRCUITS,” filed on Mar. 15, 2013. The content of the above identified patent document is incorporated herein by reference.

### TECHNICAL FILED

The present application relates generally to light fixtures and, more specifically, to a light emitting diode (LED) lighting system and control method for vending machines.

### BACKGROUND

Vending machines offer unattended sales of commodities such as snacks, canned or bottled beverages, or any of a variety of other articles. Glass front vending machines typically include light fixtures positioned to illuminate the products within the interior of the vending machine, available for purchase. Some vending machines include LED light fixtures for such illumination.

All light fixtures consume electricity, and when the light fixture inside a vending machine is “on” throughout the day, including during times when customers cannot access the machine (e.g., after business hours), energy resources are wasted. The United States Department of Energy and U.S. Environmental Protection Agency set energy savings specifications for various products. When a vending machine design meets the energy savings specifications, which have progressively become more stringent, the machines qualifies for an ENERGY STAR rating, an important attribute for many customers purchasing vending machines. However, vending machine illumination systems that meet the energy savings specifications necessary to qualify for the highest ENERGY STAR ratings using off-the-shelf components may not simultaneously meet product display illumination requirements of vending machine companies, beverage bottlers, and/or distributors.

### SUMMARY

There is a need in the art for an improved light fixture for vending machines that provides a limited level of power consumption at certain times during operation to qualify for Energy Star Tier 3, and that provides a customer-specified lighting output at other times. Embodiments of the present disclosure include a light emitting diode (LED) light fixture (also referred to as a “light strip”) capable of operating in a vending machine. The light fixture includes an LED light panel of a desired shaped with two or more independent electrical circuits formed by a plurality of LED chips in a single housing. Each electrical circuit includes and controls a mutually exclusive portion of the LED chips, and electrical circuit components that cause the respective circuit to operate as an independent LED light fixture are not dependent on any other electrical circuit.

Certain embodiments may provide various technical advantages depending on the implementation. For example, certain embodiments provide reduction of installation space occupied by the fixture, reduction in material costs, savings in installation and/or maintenance and repair labor cost, or simplification of the assembling process.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a simplified perspective view of a vending machine implementing an improved LED light fixture according to embodiments of the present disclosure;

FIG. 1A illustrates diagrammatically the location of LED light strips within the interior of a vending machine in according to embodiments of the present disclosure;

FIG. 2 depicts a block diagram of a control system within a vending machine utilizing an improved LED light fixture according to embodiments of the present disclosure;

FIG. 3A depicts an improved LED light fixture according to embodiments of the present disclosure;

FIG. 3B depicts an LED strip including LED chips in the shape of a long strip according to embodiments of the present disclosure; and

FIG. 4 depicts a process for implementing lighting modes according to embodiments of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. The phrase “at least one of,” when used with a list of items, means that different combinations of one or more of the listed items may be used, and only one item in the list may be needed. Definitions for certain words and phrases are provided throughout this patent document, those of ordinary skill in the art should understand that in many, if not most instances, such definitions apply to prior, as well as future uses of such defined words and phrases.

### DETAILED DESCRIPTION

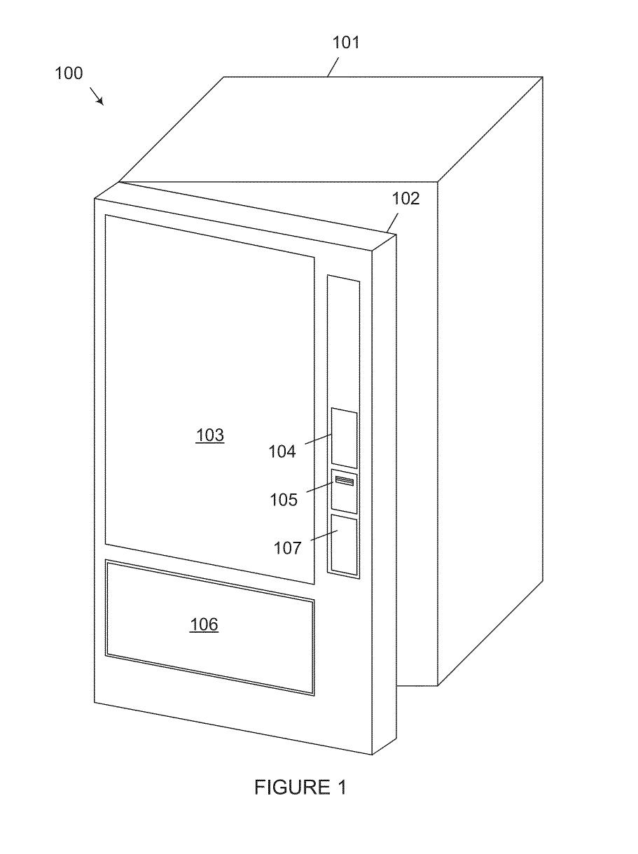

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system.

In the present disclosure, a single LED light strip for use in a vending machine incorporates two independent lighting circuits, each circuit consisting of a portion of the LED chips in the LED light strip and its own electrical circuit components, which make the circuit function as an independent LED light. The two circuits work independently of each other and can be controlled with an external control circuit. By adjusting the number of LED chips included in each circuit, the lighting output and power consumption of each circuit can be defined in the design and sizing stage as deemed necessary for applications where the LED light strip is to be used.

One application of the LED light strip described above is when there are two scenarios of different lighting output requirements for the same location in a product or process. These two scenarios may not occur at the same time and, without loss of generality, may be named Scenario #1 (in which a lower lighting output is required) and Scenario #2 (in which a higher lighting output is required). The first of the two independent circuits on the LED light strip may be designed to include the proper number of LED chips to meet the lighting output of Scenario #1, and the second independent circuit can be designed to include a number of LED chips that—when combined with all the LED chips in the first circuit—can meet the requirement of Scenario #2 through the total lighting output of the LED chips in the first and second circuit. In Scenario #1, only the first circuit will be powered, while in Scenario #2, both the first and the second circuits will be powered.

Another application of the LED light strip described above involves the lighting requirements for lighting installed at the same location and including the following two scenarios: in one scenario (Scenario #3), the lighting output is critical; in the other scenario (Scenario #4), the lighting power consumption is critical. The numbers of LED chips needed to meet the requirements of each of Scenarios #3 and #4, respectively, can be calculated or determined experimentally, and may be denoted “A” and “B,” respectively. If A equals B, there is no need to use two circuits and an LED light strip with a single circuit consisting of chips of a quantity equal to A can satisfy both scenarios. If A is not equal to B, then the first circuit can be designed to include chips of a quantity equal to the smaller of A and B, and the second circuit can be designed to consist of chips of a quantity equal to the difference between the larger and smaller values of A and B. Therefore, when only the first circuit is powered, the scenario that needs the smaller quantity of chips can be met; when both circuits are powered, the scenario that needs the larger quantity of chips can be met.

Yet another application of the LED lights strip described above is when the colors of light are required to be different in different scenarios, in which case LED chips for a desired color of light can be used for each of the different LED circuits.

Yet another application of the LED light strip described above is when the direction of light is required to be different in different scenarios. A different LED circuit with LED chips aimed for a desired direction of lighting can be used for each of the independent circuits.

The LED light strip described above can include more than two circuits and accordingly can be used in applications where there are more than two scenarios of lighting output, power consumption, color of light, or direction of light requirements on the same location at different times in the same product or process.

There are many more applications of the LED light described above in which multiple scenarios must be met, with each scenario requiring a different value for any one of the four specifications, namely lighting output, power consumption, color of light, or direction of light. An independent circuit can be incorporated in the multi-circuit LED light strip to meet each scenario or a combination of the scenarios.

FIG. 1 depicts a simplified perspective view of a vending machine implementing an improved LED light fixture according to embodiments of the present disclosure. Although certain details will be provided with reference to the components of the vending machine 100, it should be understood that other embodiments may include more, less, or different components.

Vending machine 100 includes a cabinet 101 and a service door 102 that, together, define an enclosure. In the embodiment illustrated, the service door 102 is pivotally mounted to the front of the cabinet 101 and extends all the way across the front face of the vending machine 100. In alternate designs, the service door 102 may extend only part way across the front of the vending machine, or may be formed in two portions (of equal or unequal sizes) that swing open in opposite directions.

In the embodiment illustrated in FIG. 1, the service door 102 includes a transparent front 103 (also referred to as transparent window 103) allowing the customer to view actual products available for vending, which may include snacks, packaged beverages, or both.

The vending machine 100 includes an LED light fixture configured to provide light within the service door 102 or cabinet 101. In certain embodiments, the LED light fixture illuminates the products stored within the cabinet 101 to enhance a customer's ability to see the merchandise. In certain embodiments, the LED light fixture illuminates the face of the vending machine, such as the front surface of the door, attracting a customer's attention to the machine.

Vending machine 100 also includes a customer product selection interface 104, a payment system 105, and a delivery bin door 106. In certain embodiments, the customer product selection interface 104 includes a touch-screen liquid crystal display (LCD) display and input. In the embodiments the customer product selection interface 104 includes a keypad. The customer product selection interface 104 detects customer contact with the keys of the keypad or with the touch-screen of the LCD display by detecting a physical contact of a human or by detecting pressure.

The vending machine 100 includes a payment system 105. The payment system 105 is located on a front face of the vending machine 100, such as on a front portion of the cabinet 101 or on the service door 102. In certain embodiments, the payment system 105 is included within or as part of the user interface 104. The payment system 105 includes one or more of: a bill validator, a bill recycler, a coin acceptor, a credit or debit card reader, and a cashless payment device reader, such as a reader of fobs, tags, tokens, and quick-response codes (QR codes). The payment system 105 includes a payment mechanism access for receiving paper currency, coins, or other forms of payment from the customer and returns change as necessary. In certain embodiments, payment system 105 includes a light for each payment device contained therein that indicates the status of that payment device to a user.

FIG. 1 depicts the delivery bin door 106 as positioned below the transparent window 103 and substantially across the width of the product columns behind the transparent window 103. Products available for vending are thus held in, for example, helical coils on shelves visible from the exterior through the transparent window 103 and are dropped through a space between the shelves and the transparent window 103 into the delivery bin behind delivery bin door 106. Those skilled in the art will recognize that in some vending machines, particularly beverage vending machines, an X-Y product retrieval and delivery mechanism delivers vended product to an access port 107 to the side as shown in FIG. 1, at a height convenient to the customer for product retrieval without bending over.

Those skilled in the art will recognize that the complete structure of a vending machine 100 is not depicted in the drawings, and the complete details of the structure and operation of the vending machine is not described herein. Instead, for simplicity and clarity, only so much of the structure and operation of a vending machine as is unique to the present disclosure or necessary for an understanding of the present disclosure is depicted and described.

FIG. 1A illustrates diagrammatically the location of LED light strips within the interior of a vending machine in accordance with one embodiment of the present disclosure. The lighting system employed includes one LED light strip 150 of the type described in further detail below positioned at a top of the vending machine, mounted to an upper interior wall of the cavity in which products available for vending are displayed, near the glass front (for example, near the transparent window 103). The lighting system also includes second and third LED light strip 151 and 152 on interior sidewalls of the product display cavity, also near the glass front. These three LED light strips provide illumination for the displayed products, and may be operated in an ENERGY STAR mode and in a minimum luminance mode as described in further detail below. In certain embodiments, a single LED light fixture can include multiple LED light strips 150-152.

In certain embodiments, the LED light strips 151 and 152 are alternatively disposed vertically on the same interior sidewall of the vending machine, one above the other, rather than on opposite sides of the cabinet. In such cases, a reflective strip may optionally be mounted within the interior on the opposite sidewall of the vending machine, to reflect light traveling across the front the cabinet onto the product shelves. For example, the second and third LED light strips 151 and 152 may be mounted on a right hand side interior sidewall of the vending machine, where the second LED light strip 151 is mounted on the top of the right hand side interior sidewall, and the third LED light strip 152 is mounted on the bottom of the right hand side interior sidewall. The reflective strip may then be mounted on the left hand side interior sidewall. As known in the art, a reflective strip reflects light to further diffuse light illuminating products within the cavity of the vending machine.

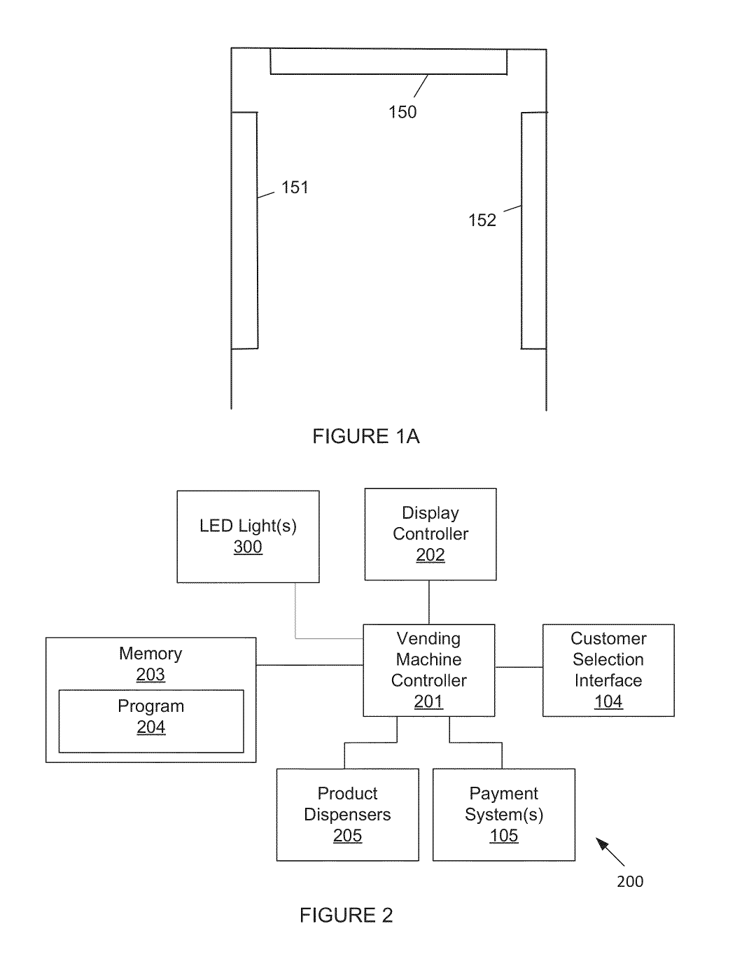

FIG. 2 depicts a block diagram of a control system 200 within a vending machine 100 utilizing an improved LED light fixture according to embodiments of the present disclosure. FIG. 2 shows selected electrical and electronic components of the vending machine's 100 control system 200 configured to enable the vending machine 100 to implement an improved LED light fixture. Although certain details will be provided with reference to the components of the control system 200, it should be understood that other embodiments may include more, less, or different components.

The control system 200 for vending machine 100 includes a programmable vending machine controller (VMC) 201, typically implemented using a programmable microcontroller mounted on or otherwise coupled to a printed circuit board (PCB) with suitable connections to a Multi-Drop Bus (MDC) for peripherals. The control system 200 includes various components coupled to the VMC 201, such as the customer selection interface 104, the payment system 105, a display controller 202, a memory 203, product dispensers 205, and an LED light fixture 300.

Coupled to VMC 201 is a display controller 202 for controlling operation of a display, such as an array of eight-segment light emitting diode (LED) character displays or a graphical (non-touchscreen) display.

VMC 201 is also coupled to a memory 203 storing a workflow program 204 for controlling the process of vend transactions within the vending machine 100. Preferably the program 204 is configured to operate with either an LCD touchscreen display or with the customer selection interface 104 described in further detail below.

VMC 201 is also coupled to product dispensers 205, such as helical coils holding products within successive convolutions and selectively driven by an electric motor to force a foremost product off a shelf to fall into a customer-accessible delivery bin, or an X-Y retrieval mechanism that retrieves a selected product from a particular queue and carries that product to a customer-accessible delivery bin or hopper.

VMC 201 is further coupled, most likely by an MDB, to one or more payment systems 105 (that is, one or more of a coin mechanism, a bill validator or bill recycler, or a magnetic card swipe reader).

The VMC 201 is configured to select a mode for the light fixture 300. The VMC 201 selects the mode based on factors, such as time of day, day of the week, date of the year, the specific products stored in the product dispensers 205, and the criticality of either lighting output or lighting power consumption. The VMC 201 selects one or more independent circuits 310, from the plurality of independent circuits 310a-b in the light fixture 300, that correspond to the selected mode.

More particularly, the VMC 201 can be programmed to identify periods of low occupancy based on whether the time of day is during normal business hours, whether the day of the week is a normal workday for the building in which the vending machine 100 is located, and whether the date of the year is a holiday. In response to determining that the current time is concurrent with a period of low occupancy, the VMC 201 selects an energy saving mode corresponding to lower lighting output level. When the energy saving mode is selected, the VMC 201 selects low wattage circuits 310. In certain embodiments, the energy saving mode corresponds to times when lighting power consumption is critical. When lighting output is critical, the VMC 201 may select one or more circuits that alone or in combination output a specified lighting output that consumes more watts than the amount of watts consumed in the energy saving mode.

The VMC 201 selects one or more circuits 310 based on the specific products stored in the product dispensers 205. The VMC 201 retrieves, from the memory 203, a merchandise-specific lighting output level that corresponds to the specific product(s) stored in the product dispensers 205. For example, XYZ Corporation may provide a specification including one or more requirements, such as that its bottled beverages to be illuminated at 1280 lumens, its canned beverages to be illuminated at 1600 lumens, and its snacks to be illuminated at 2400 lumens. The VMC 201 can be programmed to know which specific products are stored in each of the product dispensers 205.

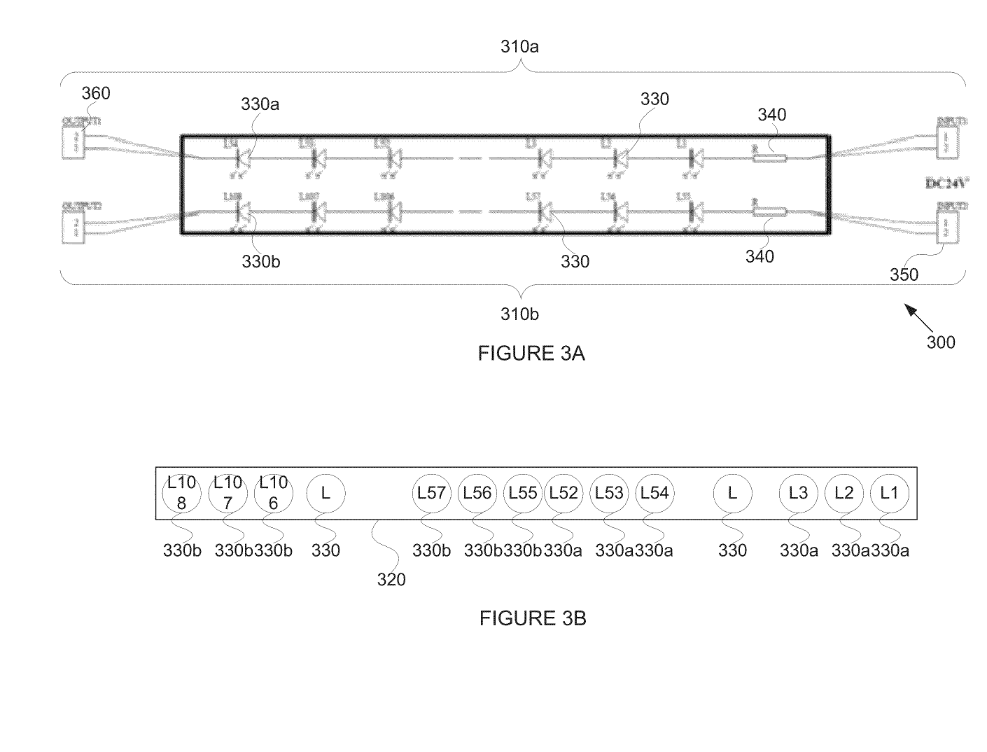

FIG. 3A depicts a schematic of an improved LED light fixture according to embodiments of the present disclosure. Although certain details will be provided with reference to the components of the LED light fixture 300, it should be understood that other embodiments may include more, less, or different components.

The LED light fixture 300 includes two or more independent lighting circuits 310a-b, and one or more LED mounting boards 315 (for example, light strips 320) including a plurality of LED chips 330. The number of independent circuits 310 in the LED light fixture 300 is any number, two or larger. The embodiment shown in FIG. 3A is a two-circuit LED light including a first lighting circuit 310a and a second lighting circuit 310b. Each circuit 310 is configured to function as an independent LED light strip 320. Each circuit 310 includes a portion of the LED chips 330 on the LED light fixture 300 and its own electrical circuit components, such as resistors 340, input terminals 350, conductor, and output terminals 360. For example, the second circuit 310b includes an input terminal 350 (labeled INPUT2), one or more resistors (R) 340, six LED chips 330b (labeled L55, L56, L57, L106, L107, and L108), and an output terminal 360 (labeled OUTPUT2). In certain embodiments, the input terminal 350 is configured to receive an input signal of 24 volts (DC24V). The first circuit 310a includes an input terminal 350 (labeled INPUT1), one or more resistors (R) 340, six LED chips 330a (labeled L1, L2, L3, L52, L53, and L54), and an output terminal 360 (labeled OUTPUT1). In certain embodiments, the input terminal 350 is configured to receive an input signal of 24 volts (DC24V).

The LED mounting board 315 can be made into any desirable shape, including: a long strip (e.g., light strip 320), a circular plate, a ring, a square plate, and so the like. That is, the LED mounting board 315 is not limited to a shape having an aspect ratio greater than one.

FIG. 3B depicts an LED mounting board including LED chips in the shape of a long strip according to embodiments of the present disclosure. The long strip shaped mounting board shown in FIG. 3B can be referred to as an LED light strip 320. The LED chips 330 belonging to different circuits 310 can be mounted on the face of the LED light 300 in any way suitable for the desired applications (also referred to as a “mode”). Some ways to distribute the LED chips 330 include:

(1) grouping the LED chips 330 of each circuit 310 together, and then locate the groups in different places on the mounting board 315 on the face of the LED light fixture 300;

(2) uniformly distributing the LED chips 330 of each circuit 310 along the length of the LED light strip 320 (if the LED light fixture 300 is formed as a strip);

(3) grouping the LED chips 330 of one circuit 310 together and mounting the group among the LED chips 330 of other circuits. For example, the LED chips 330a corresponding to the first circuit 310a are disposed on the right side of the LED light strip 320, and the LED chips 330b corresponding to the second circuit 310b are disposed on the left side of the LED light strip 320. The LED chips 330a corresponding to the first circuit 310a can be disposed in one group (for example, L1-L52 in a line and corresponding to circuit 310a) that is adjacent to a first group (for example, L55-L57 in a line) of multiple groups LED chips 330b corresponding to the second circuit 310b (for example, L106-L108 belonging to a second group of LED chips 330b corresponding to the second circuit 310b).

The two circuits 310a-b work independently of each other and can be controlled with an external control circuit, such as the VMC 201. In certain embodiments, the VMC 201 is coupled to the LED light fixture 300. In certain embodiments, the VMC 201 is coupled the input terminal 350 of each circuit 310. The VMC 201 is configured to send control signals to the control circuit 310 causing the circuits 310a-b to implement a power saving mode at a first time, a merchandise-specific power mode at a second time. The merchandise-specific power mode can be the same as or different from a full power mode. In full power mode, all of the LED chips 330 within the LED light fixture 300 are on.

By adjusting the number of LED chips 330 included in each circuit 310, the lighting output and power consumption of each circuit 310 can be defined as deemed necessary by the applications where the LED light strip 320 is used in the design & sizing stage.

As an example of using the LED light fixture 300: Two scenarios having different lighting output requirements for the same location in a product or process. In both scenarios, the vending machine 100 is a location that includes merchandise for XYZ Corporation. In Scenario #1, a first, lower lighting output level is required, and in Scenario #2, a second, higher lighting output is required. In Scenario #1, the building in which the vending machine 100 is located requires the vending machine to be illuminated at the first lighting output level during hours of low occupancy. In Scenario #2, XYZ Corporation requires the merchandise to be illuminated at the second lighting output level (also referred to as a merchandise-specific lighting output level). In Scenario #1, the first 310a of the two independent circuits coupled to the LED light strip 320 can be designed to include the proper number of LED chips 330 that can meet the lighting output of Scenario #1. That is, in Scenario #1, the vending machine implements a first lighting mode, wherein the LED light fixture 300 illuminates to the first lighting output level. In Scenario #1, the first independent circuit 310a is designed to include the number of LED chips 330a that are necessary to meet the first lighting output level. In Scenario #2, the vending machine 100 implements the merchandise-specific mode, wherein the LED light fixture 300 illuminates to the second lighting output level, the merchandise-specific level, in order to meet the requirements of XYZ Corporation. These two scenarios do not occur at the same time. In Scenario #2, the second circuit 310b is designed to include the number of LED chips 330b that when combined with all the LED chips 330a in the first circuit 310a, the total lighting output of the LED chips in the first 310a and second circuit 310b meets the requirement of Scenario #2. That is, in Scenario #2, the LED light fixture 300 uses both circuits 310a-b to turn on the LED chips 330a and 330b associated with circuits 310a and 310b to illuminate to the second, higher, merchandise-specific lighting level. In Scenario #1, only the first circuit 310a is powered on; while in Scenario #2, both the first and the second circuit will be powered on.

As an example of using the LED light fixture 300: The lighting requirements for the LED light 300 installed at the same location include the following two scenarios: in Scenario #3, the lighting output is critical; and in Scenario #4, the lighting power consumption is critical. The numbers of LED chips 330 needed to meet the requirements of each of Scenarios #3 and #4, respectively, can be calculated or determined by experiments. In Scenario #3, the lighting output level requirement necessitates the number A of LED chips 330 to be illuminated. In Scenario #4, the lighting power consumption level requires the number B of LED chips 330 to be illuminated. If A equals B, there is no need to use two circuits; a LED light fixture 300 with a single circuit comprising LED chips of a quantity equal to A would satisfy both scenarios.

In certain embodiments, if A is not equal to B, then the first circuit 310a is designed to include LED chips 330a of a quantity equal to the lesser of A and B; and the second circuit 310b is designed to include LED chips 330b of a quantity equal to the difference between the larger and smaller values of A and B. Therefore, when only the first circuit 310a is powered on, the scenario that needs the smaller quantity of LED chips 330 can be met. Also, when both circuits 310a and 310b are powered on, the scenario that needs the larger quantity of chips is met.

In certain embodiments, a Scenario #5 requires the LED chips 330b of the second circuit 310b to be illuminated without illuminating the LED chips 330a of the first circuit 310a. That is, in Scenario #5, the second circuit 310b and the corresponding LED chips 330b are turned on, while the first circuit 310a and the corresponding LED chips 330a are turned off.

As an example of using the LED light fixture 300: The colors of light in a first scenario differ from the colors of light in a second scenario. A different LED circuit with LED chips for a desired color of light is used for each of the scenarios. For example, Scenario #6 the LED chips 330 illuminate red, in Scenario #7 the LED chips 330 illuminate blue, Scenario #8 the LED chips 330 illuminate yellow, and in Scenario #8 the LED chips 330 illuminate purple (e.g., using a combination of the LED chips 330 of Scenarios #6 and #7).

As an example of using the LED light fixture 300: The required direction of light is different in different scenarios. The direction of light in a first scenario differs from the direction of light in a second scenario. A different LED circuit 310 with LED chips 330 aimed for a desired direction of light can be used for each of the scenarios.

In certain embodiments, the LED light fixture 300 includes more than two circuits 310. Accordingly, the LED light fixture 300 can be used in applications where there are more than two scenarios of lighting output, power consumption, color of light, or direction of light requirements exist for the same location at different times for the same product or process.

The LED light fixture 300 implements many more applications or modes. In certain embodiments, the LED light fixture 300 implements multiple scenarios at the same time. Each scenario requires a different value of any one of the four specifications, namely lighting output, power consumption, color of light, or direction of light. An independent circuit 310 is incorporated in the multi-circuit LED light fixture 300 to meet each or a combination of the scenarios.

As an implementation example of using the LED light fixture 300: According to specifications for vending machines defined by a beverage bottler, the LED light power consumption is limited to be below 3 Watts (3 W) during an energy saving mode, in order to meet the Energy Star Tier 3 energy consumption requirements. In normal operating mode, however, three 10-W LED light strips 320a-c are typically required in order to make the vending machine meet bottler's illumination requirement during vend transactions. As a solution, a top LED light fixture 300 includes two independent circuits 310a-b. The first circuit 310a consumes only 3 W when powered, and the second circuit consuming about 7 W when powered. During energy saving mode, only the 3-W circuit 310a on the top LED light strip 320a is powered, the second circuit 310b on the top LED strip 320a and the other two LED strips 320b-c are all powered off. During normal operating mode, both circuits on the top LED strip 320a and the other two LED strips are powered on 320b-c.

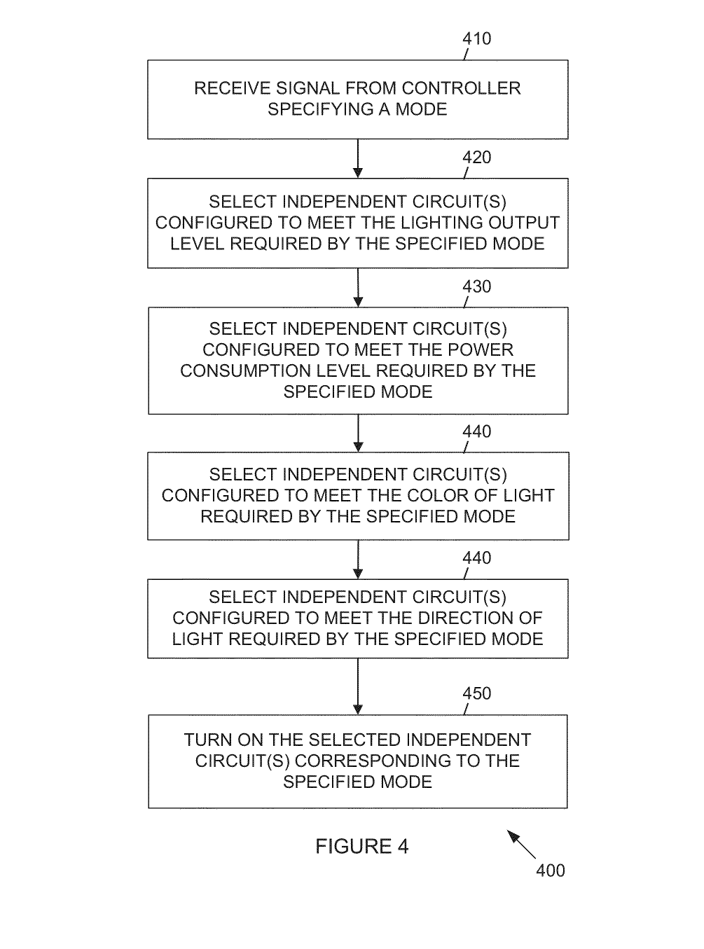

FIG. 4 depicts a process 400 for implementing lighting modes according to embodiments of the present disclosure. The LED light fixture 300 is configured to implement the process 400 for implementing lighting modes. In certain embodiments, the control system 200 is configured to implement the process 400 for implementing lighting modes. A controller, such as the VMC 201, coupled to the light fixture 300 is configured to send control signals to the LED light fixture 300 indicating a mode to be entered to meet one or a combination of scenarios. The controller selects the mode to be entered based on one or more factors. The embodiment of the process 400 shown in FIG. 4 is for illustration only. Other embodiments could be used without departing from the scope of this disclosure.

In block 410, light fixture 300 receives a signal from the controller specifying a mode to be entered by the light fixture.

In block 420, the light fixture 300 or control system 200 select independent circuit(s) configured to meet the lighting output level required by the specified mode.

In block 430, the light fixture 300 or control system 200 select independent circuit(s) configured to meet the power consumption level required by the specified mode.

In block 440, the light fixture 300 or control system 200 select independent circuit(s) configured to meet the color of light required by the specified mode.

In block 450, the light fixture 300 or control system 200 select independent circuit(s) configured to meet the direction of light required by the specified mode.

In block 460, the light fixture 300 or control system 200 turn on the selected independent circuit(s) corresponding to the specified mode. Also, the light fixture 300 or control system 200 turn off the independent circuit(s) 310 and other LED light strips 320 that do not correspond to the specified mode.

It is important to note that while the present disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the process 400. Examples of machine usable, machine readable or computer usable, computer readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although various features have been shown in the figures and described above, various changes may be made to the figures. For example, the size, shape, arrangement, and layout of components shown in FIGS. 1 through 3 are for illustration only. Each component could have any suitable size, shape, and dimensions, and multiple components could have any suitable arrangement and layout. Also, various components in FIGS. 1 through 3 could be combined, further subdivided, or omitted and additional components could be added according to particular needs. Further, each component in a device or system could be implemented using any suitable structure(s) for performing the described function(s). In addition, while FIG. 4 illustrates various series of steps, various steps in FIG. 4 could overlap, occur in parallel, occur multiple times, or occur in a different order.

Although examples and embodiments of the present disclosure have been described in detail, those skilled in the art will understand that various changes, substitutions, variations, and improvements disclosed herein may be made without departing from the spirit and scope of the disclosure in its broadest form. Descriptions of well-known functions and constructions have been omitted for clarity and conciseness.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method, comprising:
based upon a signal specifying a mode of a single light emitting diode (LED) light strip containing two or more independent circuits each having one or more serially-connected LED chips,
for a first mode, powering at least one independent circuit configured to meet a power consumption specification of the first mode while leaving any remaining independent circuits unpowered to illuminate only LEDs within the LED chips of the powered independent circuit, wherein the at least one independent circuit is selected from the independent circuits in the light strip, and
for a second mode, powering at least two or more of the independent circuits configured to meet an illumination output specification of the second mode.

2. The method of claim 1, wherein the specification of each mode includes at least one of:
a power consumption level corresponding to the specified mode, and
a lighting output corresponding to the specified mode.

3. The method of claim 1, wherein the specification of each mode includes a color of light corresponding to the specified mode.

4. The method of claim 1, wherein the specification of each mode includes a direction of light corresponding to the specified mode.

5. The method of claim 1, wherein the plurality of circuits control a lighting output, a power consumption, a color of light, and a direction of light corresponding to the specified mode of the LED light strip.

6. The method of claim 1, further comprising:
selecting a mode to specify for the light strip; and
sending one or more signals to the light strip to power independent circuits within the light strip based on the specified mode.

7. The method of claim 6, wherein selecting the mode is based on at least one of:
a time of day;
a day of a week; and
a date in a year.

8. A light emitting diode (LED) light strip, comprising:
an LED mounting board comprising a plurality of LED chips forming a plurality of independent circuits, each independent circuit comprising:
a portion of the plurality of LED chips, and
electrical circuit components comprising at least one of a resistor, input terminal, and output terminal, the electrical circuit components configured to cause the respective circuit to function independent from remaining circuits in the plurality of circuits based on a specified mode of the LED light fixture; and
a covering enclosing at least a portion of the LED mounting board, the covering configured to allow illumination from the LED chips to pass through predetermined portions thereof.

9. The LED light strip of claim 8, wherein the electrical circuit components are further configured to turn on at least one selected independent circuit corresponding to the specified mode and leave off independent circuits not corresponding to the specified mode, and
wherein the at least one selected independent circuit is selected from the plurality of independent circuits in the LED light strip.

10. The LED light strip of claim 9, wherein the at least one selected independent circuit is configured to meet a specification of the specified mode, the specification comprising at least one of:
a power consumption level corresponding to the specified mode, and
a lighting output corresponding to the specified mode.

11. The LED light strip of claim 9, wherein the at least one selected independent circuit is configured to meet a specification of the specified mode, the specification comprising at least one of:
a color of light corresponding to the specified mode; and
a direction of light corresponding to the specified mode.

12. The LED light strip of claim 8, wherein the plurality of circuits control a lighting output, a power consumption, a color or light, and a direction of light corresponding to the specified mode of the LED light fixture.

13. The LED light strip of claim 8, wherein a first circuit of the plurality of circuits comprises a first portion of the plurality of LED chips,
a second circuit of the plurality of circuits comprises a second portion of the plurality of LED chips, and
a third circuit of the plurality of circuits comprises a third portion of the plurality of LED chips, wherein the first, second, and third portions are mutually exclusive;
wherein the plurality of LED chips of the mounting board are distributed according to at least one of the following distributions:
the first portion of the LED chips are grouped together in a first area of the LED mounting board, and the second portion of the LED chips are grouped together in a second area of the LED mounting board different from the first area;
the first and second portions of LED chips are uniformly distributed along a length of the mounting board, if the mounting board is an LED strip; and
the first portion of the LED chips are grouped together in the first area of the LED mounting board, and the second and third portions of the LED chips are grouped together in the second area.

14. A system, comprising:
a light emitting diode (LED) light strip comprising:
an input terminal configured to receive a signal specifying a mode of the LED light fixture;
an LED mounting board comprising a plurality of LED chips forming a plurality of circuits, each circuit comprising:
a portion of the plurality of LED chips, and
electrical circuit components comprising at least one of a resistor, input terminal, and output terminal, the electrical circuit components configured to cause the circuit to function independent from the other circuits in the plurality of circuits;
a controller coupled to the LED light fixture and configured to:
select at least one independent circuit configured to meet a specification of the specified mode, wherein the at least one independent circuit is selected from the plurality of independent circuits in the light strip;
turn on the at least one selected independent circuit corresponding to the specified mode; and
leave off independent circuits within the LED light strip not corresponding to the specified mode.

15. The system of claim 14, wherein the specification includes at least one of:
a power consumption level corresponding to the specified mode, and
a lighting output corresponding to the specified mode.

16. The system of claim 14, wherein the specification includes a color of light corresponding to the specified mode.

17. The system of claim 14, wherein the specification includes a direction of light corresponding to the specified mode.

18. The system of claim 14, wherein the plurality of circuits control a lighting output, a power consumption, a color or light, and a direction of light corresponding to the specified Mode of the LED light strip.

19. The system of claim 14, wherein the controller is further configured to select the specified mode based on at least one of:
a time of day;
a day of a week; and
a date in a year.

20. A vending machine comprising the system of claim 14.
